(19) United States
(12) Patent Application Publication
(10) Pub. No.: US 2003/0157213 A1
(43) Pub. Date: Aug. 21, 2003

(54) Nutrient chewing gum

(76) Inventor: Jeffrey Jenkins, Brooklyn, NY (US)

Correspondence Address: RONALD B. SHERER, 103 SO. SHAFFER DRIVE, NEW FREEDOM, PA, 17349, US

(21) Appl. No.: 10/077,602

(22) Filed: Feb. 19, 2002

(51) Int. Cl. A23G 3/30

(52) U.S. Cl. 426/3

(57) ABSTRACT

Chewing gum with a nutritionally beneficial additive, such as aloe vera, is disclosed.

### FIELD

This invention relates to the field of chewing gum, and more particularly, to chewing gum containing beneficial nutrients.

### BACKGROUND

Chewing gum comprised of one or other of many types of gum bases has been known since the time of the Greeks, and many gums have had additives including breath fresheners, aspirin, laxatives, antacids, pepsin and so-called “dietary” drugs about which there is much controversy. In essence, today's gums are composed of a natural or synthetic gum base, with approximately sixty percent of sugar added, and essentially no nutrients.

### SUMMARY

For the first time, the present invention provides a gum with a significant nutritional value, and this nutritional value is preferably provided by the incorporation of aloe vera into the gum during its manufacture.

### BRIEF DESCRIPTION OF THE DRAWING

FIG. 1 schematically illustrates one preferred embodiment of manufacturing chewing gum with a substantial nutritional value.

### DETAILED DESCRIPTION

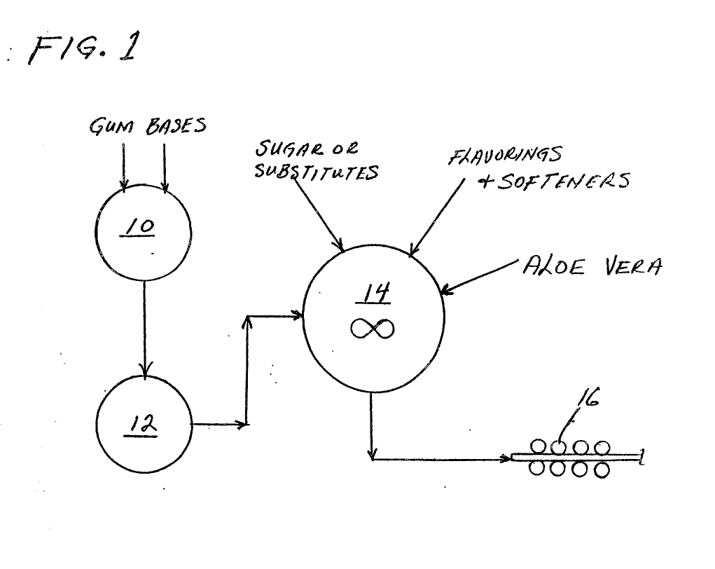

Referring to FIG. 1, the gum base is typically made by melting chicle or other latex's and/or other natural or synthetic base elements in the conventional manner as illustrated by melting kettle 10 to form a flowable syrup base. The warm syrup base may be purified by straining or other known purification methods in purifier 12. The gum base is then passed to one or more mixing tanks 14 where sugar, or artificial sweeteners, are added. In addition, softeners such as for bubble gum, and/or flavorings such as mint, cherry, cinnamon and/or others, and breath fresheners and/or other conventional additives may be added. However, in addition to conventional additives, the present invention provides that a nutritionally beneficial additive is added. Preferably, this nutritionally beneficial additive is derived from the aloe vera plant.

From ancient times, the aloe vera plant has been believed to contain extremely valuable nutrients, and modern science has now confirmed this belief to be scientifically correct. For example, it is now known that the gel from the leaves of a mature aloe vera plant comprises such beneficial nutrients as glucose, calcium, magnesium, potassium, iron, chlorides and transaminoses, plus carbohydrates, proteins and cholesterol. In addition, aloe vera has been discovered to contain many vitamins including A, B complex, B₁, B₂, B₃, C, E, choline, niacin, folic acid and many other vitamins, minerals and enzymes as reported, for example, in the book entitled, “Our Need For Aloe Vera”, by Rafael B. Lugay, Jr., M.D., which is hereby incorporated by reference. Thus, by the addition of a single added component of aloe vera gel the gum may become a significant source of nutrients instead of only sugar and flavorings.

As further illustrated in FIG. 1, the gum may be further processed in the conventional manner such as by cooling, kneading and forming into sticks or other shapes of gum in the product formers 16. Thereafter, the gum may be packaged in the conventional manner for shipment and sale.

The amount of aloe vera to be added may vary widely depending upon the amount of nutrients which are desired in each piece of gum. For example, the amount may be equal to or greater than the amount of sugar if a high strength vitamin-enriched gum is desired. Alternatively, the amounts of aloe vera may be in the order of 2% to 40% by weight of the gum base if substantial but less nutrients are desired. More preferably, amounts in the order of 5% to 15% of the gum base are preferred for an optimum cost benefit ratio.

With regard to the mode of introduction of the aloe vera, it is preferred that an aloe vera gel be formed, in accordance with known methods of forming such aloe vera gels, and that the aloe vera gel be added in the form of a gel or liquid since the gel is 96% water and therefore water soluble.

From the foregoing description of one preferred embodiment of the invention, it will be understood that the addition of aloe vera in any form into chewing gum is provided in order to markedly enhance the medical value of the gum so as to also provide a substantial nutrient value not previously known in the field of chewing gum. Of course, it is understood that the foregoing description is purely illustrative of the principles of the invention, and that the true invention is to be determined solely by the following claims interpreted under the doctrine of equivalents.

What is claimed is:

1. A method of manufacturing chewing gum comprising:
(a) heating and melting gum elements to form a heated and flowable gum base;
(b) passing said flowable gum base to a mixing stage;
(c) mixing said gum base in said mixing stage;
(d) while mixing said gum base adding a nutritional ingredient to said gum base; and
(d) cooling said mixed gum base for further processing.

2. The method of claim 1 wherein said nutritional ingredient includes vitamins.

3. The method of claim 2 wherein said vitamins include at least one of the group of vitamins A, B and C.

4. The method of claim 2 wherein said nutritional ingredient also includes minerals.

5. The method of claim 4 wherein said minerals include at least one of the group of calcium, magnesium, potassium, iron and chlorides.

6. The method of claim 1 wherein step (d) includes adding an extract of the aloe vera plant.

7. The method of claim 1 wherein step (d) includes adding aloe vera gel.

8. The method of claim 1 wherein step (d) includes adding aloe vera gel in a hydrated form.

9. The method of manufacturing chewing gum comprising:
(a) forming a heated gum base;
(b) passing said heated gum base to a mixer;
(c) adding at least one additive to said gum base in said mixer; and
(d) adding aloe vera to said gum base in said mixer in addition to said at least one additive.

10. A piece of chewing gum produced by the method of claim 1.

11. A piece of chewing gum produced by the method of claim 9.

12. The method of claim 1 wherein the amount of said nutritional ingredient is in the order of 2% to 40% by weight of said gum base.

13. The method of claim 9 wherein the amount of said aloe vera is in the order of 2% to 40% by weight of said gum base.

14. The method of claim 13 wherein the amount of said aloe vera is in the order of 5% to 15% by weight of said gum base.
